(19) United States
(12) Patent Application Publication
(10) Pub. No.: US 2006/0162952 A1
(43) Pub. Date: Jul. 27, 2006

(54) Litz wire coils for electronic machines

(75) Inventors: Irene Olbrich, Berlin (DE); Joachim Risse, Berlin (DE); Klaus Schafer, Nurnberg (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/540,282

(22) PCT Filed: Dec. 12, 2003
(86) PCT No.: PCT/EP03/14145

§ 371 Date: Feb. 9, 2006

(30) Foreign Application Priority Data
Dec. 20, 2002 (DE) 102 60 317.0

(51) Int. Cl. H01B 3/44

(52) U.S. Cl. 174/128.1; 174/110 R

(57) ABSTRACT

The aim of the invention is to improve the electrical and mechanical properties of a litz wire conductor (1) for coils of electric machines. For this purpose, the interstices between the filaments (3) of a conductor (1) are filled with an elastic potting compound (4). In order to allow for more regular marginal field intensities in the circumferential area, the potting compound (4) can be electrically conducting. For filling the interstices, the individual filaments (3) can also be provided with a coating which accelerates curing of the steeping agent.

The present invention relates to a coil for an electric machine with one or more windings, with each winding being implemented as a stranded wire having a plurality of filaments. The invention also relates to a corresponding method for producing a coil for an electric machine with stranded wire technology.

Electric machines frequently use windings in the form of pulled coils, which are predominately fabricated from rectangular conductors. The rectangular conductors employed thus far were typically in the form of solid aluminum or copper conductors. However, is also known to use for such application stranded wires which are rolled into rectangular profiles.

In this context, the published application WO 02/11268 discloses windings for electric machines with conductors made of stranded wire. The windings having coils made of stranded wire can be more easily manufactured than conventional pulled coils made of rectangular wires. The term “stranded wire” has the conventional meaning in this technical field. A stranded wire includes a plurality of copper wires or filaments, which are stranded and pressed together. The wires themselves are typically not insulated; however, an exterior insulation is applied to the stranded wire, which can have a square or rectangular cross-section. The disclosed coils are wound both on edge and flat and are made of stranded wire having a rectangular cross-section. Such windings can be used, inter alia, for high-voltage or low-voltage electric rotary machines.

The German laid-open application DE 199 05 747 also discloses a method and a device for manufacturing a coil from a rectangular wire. A round wire with a circular cross-section is wound onto a reel. When a coil winding motor turns a coil form, the round wire is pulled from the reel. Rollers arranged in a rectangle press the round wire so as to produce a rectangular wire with a rectangular cross-section. The rectangular wire is then it directly wound onto the coil form to produce a coil with the rectangular wire.

The German patent DE 44 14 527 also discloses an electronically commutated DC machine. The machine has winding sections made of one or several stranded wires with a hardened plastic material disposed around the periphery or in the interstices, with each stranded wire including a plurality of thin filaments, which are individually insulated and are twisted within the stranded wire. The conductor material of each winding section is pressed together with a liquid resin to produce a stator winding with a conductor material fraction of 70 to 90 vol. %.

The windings of electric machines are impregnated add stiffness, to prevent electric breakdown in the windings, and protect the windings from contaminants from the environment. The windings are typically impregnated with a resin disposed between the wires or the stranded wires, whereby the resin is subsequently hardened, as mentioned above.

It is an object of the present invention to improve the protection of windings produced with stranded wire technology and, optionally, also to improve their electrical properties.

The object is solved by the invention by a coil for an electric machine with one or more windings, wherein each winding is formed as a stranded wire having a plurality of filaments, and wherein cavities between the filaments are filled with a solid or elastic, optionally electrically conducting, filling material.

The aforementioned object is also solved by the invention by a method for producing a coil for an electric machine by coating filaments of a stranded wire with an coating that activates hardening, by forming the stranded wire into a predefined coil form, and by impregnating the formed stranded wire with a hardenable filling material, which hardens upon contact with the coating.

The interior of the stranded wire can thereby also be protected from environmental contaminants, and from electrical breakdowns and the like. Moreover, a well-defined insulation can be produced between the filaments of the stranded wire, which helps improve the electrical properties.

Each stranded wire used for winding the coil can also be surrounded by the filling material along its circumference. With this approach, the filaments located at the circumference of a coil can also be effectively protected.

The stranded wire used for the coil can be rolled into a rectangular profile. This can provide a high slot fill factor, because the cavities associated with round wires are eliminated. The rectangular stranded wires can be provided with the respective filling material either before or after the coils are wound.

The filling material can consist of an electrically conducting material, which can distribute the electric field strength in the peripheral region of a stranded wire more uniformly. Filling the cavities in the stranded wire also ensures an effective heat transfer and improves the mechanical properties of the windings in the region of the winding head. The dimensional stability is also improved and the fill factor of the conductor material is increased.

The filling material for the interstices or cavities of the stranded wire can be highly flexible or even viscoelastic. This has the advantage that due the applied pressure, the interstices between the stranded conductors are already effectively filled during the winding process.

Preferably, the cavities between the filaments in the stranded wires are filled by extrusion.

Advantageously, the surface of the filaments is enclosed by a coating that activates a hardening process in the filling material. The impregnating resin is can be prevented from leaking out of the cavities by having the coating function, for example, as an accelerator or as a catalyst.

The present invention will now be described in more detail with reference to the appended drawings, wherein:

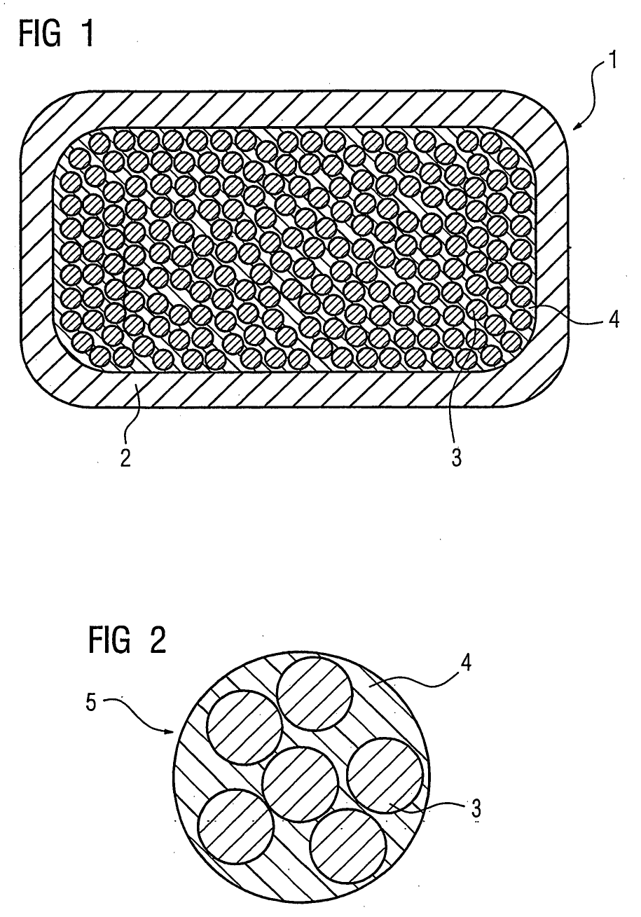

FIG. 1 shows a cross-section through a coil according to the invention;

FIG. 2 shows a cross-section through a stranded wire used to wind a coil according to FIG. 1;

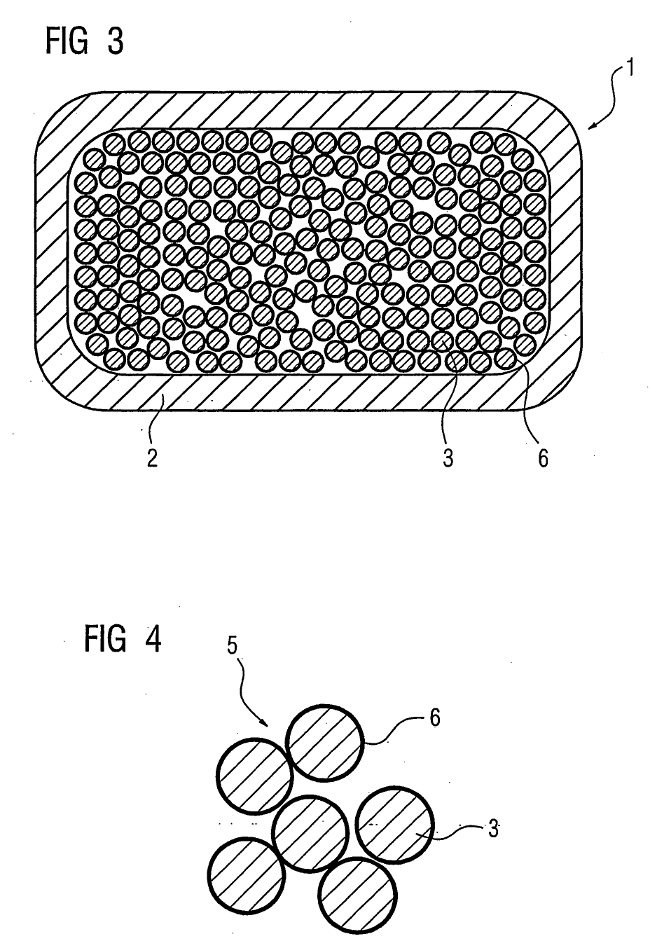

FIG. 3 shows a cross-section through a coil according to another embodiment of the invention; and

FIG. 4 shows a cross-section through a stranded wire used to produce a coil according to FIG. 3.

The following embodiments represent preferred embodiments of the present invention.

FIG. 1 shows a cross-sectional view of a coil or conductor 1 of a type typically inserted in the slots of an electric machine. Depending on the particular embodiment, the conductor 1 includes a subconductor or main insulation 2 on the periphery. A plurality of filaments 3 is arranged inside the insulation 2. An elastic embedding material 4 is disposed between several of the filaments 3 and optionally also between the filaments 3 located at the edge and the insulation 2.

The elastic embedding material 4 for filling the cavities in the stranded conductor 1 provides excellent heat transfer between the filaments 3 and improves the mechanical properties of a winding in the region of the winding head. In addition, the embedding material 4 increases the dimensional stability of the conductor 1, without adversely affecting the manufacturing advantages of the stranded wire technology, namely simplified insertion of the conductors into the slots and easier bending in the region of the winding head. Advantageously, the stranded wire technology still achieves the higher fill factors of the conductor material in the slots, because only the cavities between the filaments 3 are filled with the elastic embedding material.

The elastic filling material is preferably a resin mix and optionally includes additives for providing electrical or thermal conductivity. The resin can be, for example, mixtures of epoxy resins, polyester resins, polyurethane, silicone resins or rubber, elastomers, but also thermoplastic compounds. The copper conductors of the stranded wires are filled with the elastic material by impregnation, injection molding, extrusion, and the like. The glass transition temperatures of the filling materials can be between −60° C. and +90° C.

The conductor 1 is manufactured by winding a stranded wire 5 illustrated in FIG. 2 multiple times about a frame or bobbin, or already into the corresponding slot of the electric machine. The individual stranded wires 5 are subsequently pressed against each other for attaining, for example, the rectangular cross-section of the conductor 1 illustrated in FIG. 1. Due to the fact that the embedding material is quite elastic, optionally viscoelastic, all cavities in the conductor 1 are filled with the embedding material 4 or with other filaments 3. The embedding material not only enhances the mechanical stability of the filaments or stranded wires relative to each other, but also improves heat transport, which conventional techniques cannot always provide. For example, the intermediate spaces of the stranded conductor wires of windings that are insulated “resin-rich”, and of winding insulations that are impregnated individually or as a whole with an accelerator-free impregnating compound, can not always be filled or not always be adequately filled with resin, because the impregnating resin can occasionally leak out.

In conventional windings made from conductors consisting of stranded wire without the filling material, the peripheral region of the rolled rectangular conductor can have a greater electric field strength at the edge than conventional solid copper conductors due to the smaller radii of the copper filaments 3. This can cause breakdowns to the adjacent iron or partial breakdowns. The greater electric stress reduces the service life of the insulation for the same insulator thickness. An increase in the thickness of the insulators decreases the efficiency of the machine. According to an advantageous embodiment of the present invention, an elastic, electrically conducting filling material is applied into the interstices between the filaments 3 as well as onto the surface of the conductor 1 which is made of several stranded wires 5.

The electrical conductivity of the elastic filling material can be adjusted to a desired value by adding graphite or another electrically conducting filling material. Typical values for the specific volume resistance are, for example, 1-250 kOhm×cm. The thermal conductivity of the pressed stranded copper wires can be improved by adding filling materials with a higher thermal conductivity, such as aluminum oxide, -nitride, boron nitride.

The adjusted conductivity is significantly below that of copper, but is sufficient to achieve equipotential regions on the surface of the conductor and hence a uniform distribution of the field strength in the peripheral region of the stranded wire conductor. The same utilization, i.e., the conductor cross-section, can be maintained as for the solid conductors used to date.

Another embodiment of the present invention is shown in FIG. 3. The conductor 1 is pressed into the shape of a rectangle and also has a plurality of filaments 3, which are located inside the insulation 2. Each of the filaments 3 is covered with a coating 6 that activates hardening.

A corresponding stranded wire 5 is shown in FIG. 4. The unmounted stranded wire 5 is pulled through a bath before being processed further, thereby applying to the individual filaments 3 a coating that activates hardening. The coated stranded wires are then suitably wound and pressed into the desired shape to produce the conductor 1.

Application of the coating 6, which includes an accelerator or a catalyst to activate hardening, to the stranded wire and/or the conductor 1 made of several stranded wires, chemically activates and binds the accelerator-free impregnating compound disposed between the stranded wires. The impregnating compound can thus be prevented from leaking out, which could otherwise occur due to insufficient hardening between the filaments 3. The cavities depicted in FIG. 3 between the individual filaments and in the peripheral region between the filaments and the insulation 2 are then completely filled by the impregnating process. This provides, as mentioned above, excellent heat transfer and improves the mechanical and electrical properties of the winding, in particular in the region of the winding head.

Accelerator-free impregnating compounds in this context are, for example, epoxy resin mixtures, which harden at a certain temperature and within an acceptable time only through reaction with an accelerator. However, the accelerator is not contained directly in the mixture, so as not to shorten the shelf life of the resin mixture. Instead, the accelerator is applied in or on the objects to be impregnated, in this case the stranded copper wire.

A coating that activates hardening is, for example, a varnish or resin mix containing an accelerator, consisting of a binder and an accelerator matched to the impregnating compound. This can be, for example, an amine, a Lewis acid or Lewis base, a quaternary ammonium or phosphonium compound, or catalytic and peroxide hardening activators. As mentioned above, the coating is applied, for example, by immersing the stranded copper wires and subsequently evaporating the solvent fractions and optionally hardening of the applied coating.

1. A coil for an electric machine, comprising:
one or more windings, each winding implemented as a stranded wire with a plurality of filaments;
a solid or elastic filler material for filling cavities between the filaments; and
a coating which surrounds a surface of the filaments and is configured to activate a hardening of the filling material.

2. The coil of claim 1, wherein the stranded wire has an outer circumference which is surrounded by the filling material.

3. The coil of claim 1, wherein the stranded wire is rolled so as to assume a rectangular profile.

4. The coil of claim 1, wherein the filling material is electrically conducting.

5. The coil of claim 1, wherein the filling material is viscoelastic.

6. (canceled)

7. The coil of claim 6, wherein the coating comprises an accelerator or a catalyst.

8. A winding for an electric machine, comprising a coil having one or more windings, as each winding implemented as a stranded wire with a plurality of filaments, a solid or elastic filler material for filling cavities between the filaments and a coating which surrounds a surface of the filaments and is configured to activate a hardening of the filling material.

9. An electric machine with a winding, comprising a coil having one or more windings, each winding implemented as a stranded wire with a plurality of filaments, a solid or elastic filler material for filling cavities between the filaments and a coating which surrounds a surface of the filaments and is configured to activate a hardening of the filling material.

10. A method for producing a coil for an electric machine, comprising the steps of:
coating filaments of a stranded wire with a coating configured to activate hardening;
forming the stranded wire to a predetermined coil shape; and
impregnating the formed stranded wire with a hardenable filling material, which hardens upon contact with the coating.

11. The method of claim 10, wherein the coating comprises an accelerator or a catalyst.

12. A method for producing a coil having one or more windings, each winding implemented as a stranded wire with a plurality of filaments, a solid or elastic filler material for filling cavities between the filaments and a coating which surrounds a surface of the filaments and is configured to activate a hardening of the filling material, said method comprising the step of filling cavities between the filaments by extrusion.
